(19) United States
(12) Patent Application Publication
(10) Pub. No.: US 2017/0127618 A1
(43) Pub. Date: May 11, 2017

(54) LANDSCAPE EDGING AND ILLUMINATION SYSTEMS

(71) Applicant: Terence Bell, Macomb, MI (US)

(72) Inventor: Terence Bell, Macomb, MI (US)

(21) Appl. No.: 15/226,736

(22) Filed: Aug. 2, 2016

Related U.S. Application Data
(60) Provisional application No. 62/253,474, filed on Nov. 10, 2015.

(51) Int. Cl. A01G 1/08; A01G 7/04

(52) U.S. Cl. CPC A01G 1/08; A01G 7/045

(57) ABSTRACT

A landscape edging and illumination system including a landscape edging and illumination assembly having a planar member, a tubular member, and a lighting string; wherein the planar member is flexible and structured to be implanted into a ground volume for use. The planar member may have medial ribbing, and the tubular member is structured to be located above ground. The side wall of the tubular member is transparent such that illumination can be emitted there from.

### CROSS-REFERENCE TO RELATED APPLICATION

The present application is related to and claims priority from prior provisional application Ser. No. 62/253,474, filed Nov. 10, 2015 which application is incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of landscaping and more specifically relates to a landscape edging and illumination system.

2. Description of Related Art

Landscape edging is very widely used to provide demarcation between areas of lawns, gardens and the like. For instance, landscape edging may be used to form a barrier between botanical types, wherein, for example, on one side thereof is a lawn and on the other side thereof is a flower garden. In order to provide a barrier to passage therethrough of flora, landscape edging is implanted into the ground along the line of selected demarcation, and a portion thereof is located above the surface of the ground. Usually any illumination is in the form of a series of discrete lighting units which are partly implanted into the ground and which operate on a low voltage line supplied from the home utility service. These units can sometimes be the target of vandals or may be the accidental victims of an untoward incident, such as being hit by a lawn mower. Further, conventional lighting may be expensive to use for extended periods. Landscape edging is often singular in purpose. A multi-functional landscape edging and lighting system is desired.

Several attempts have been made to solve the above-mentioned problems such as those found in U.S. Pub. No. 2006/0277823 to Douglas Barnett and Attilio Renon, U.S. Pat. Nos. 6,449,897 to Johannes N. Gaston, 5,438,804 to Donald J. Reum and Mark Reum. This art is representative of landscaping accessories. However, none of the above inventions and patents, taken either singly or in combination, is seen to describe the invention as claimed.

Preferably, a landscape edging and illumination system should provide modular means to edge and illuminate landscaping and, yet would operate reliably and be manufactured at a modest expense. Thus, a need exists for a reliable landscape edging and illumination system to avoid the above-mentioned problems.

### BRIEF SUMMARY OF THE INVENTION

In view of the foregoing disadvantages inherent in the known landscaping accessory art, the present invention provides a novel landscape edging and illumination system. The general purpose of the present invention, which will be described subsequently in greater detail is to provide an efficient and effective means to illuminate and edge landscapes.

The present invention relates to landscape edging used to demarcate areas of lawns, gardens and the like, and more particularly to an illuminated landscape edging. Increasingly, homeowners are installing landscape lighting to illuminate their lawns and other landscape features.

A landscape edging and illumination system is disclosed herein, in a preferred embodiment, comprising: a landscape edging and illumination assembly having a planar member, a tubular member, and a lighting string; wherein the planar member is flexible and structured to be implanted (vertically) into a ground volume for use. The planar member may comprise medial ribbing, and the tubular member is structured to be located above ground. The side wall of the tubular member is transparent such that illumination can be emitted there from.

The planar member preferably comprises at least one end-hook; wherein the end-hook anchors the planar member into a ground volume. As such the end-hook anchors the planar member into the ground volume to promote stability in use. The landscape edging and illumination assembly is preferably integrally assembled of plastic (or other suitably equivalent material) to provide longevity in service (since it doesn't corrode).

The side wall of the tubular member comprises a slot; wherein the lighting string passes through the slot; the lighting string comprises wiring to be connected to an external power source of electricity (which may comprise solar energy with solar energy storage means or an AC source). The landscape edging and illumination assembly is able to be controlled via an on/off switch provided. The landscape edging and illumination assembly is able to be cut to a desired length such that they can be fit to a particular landscaping project to illuminate such project during low light periods; the landscape edging and illumination assembly configured to be vertically-installed. The landscape edging and illumination assembly comprises at least one end to each modular-section (each end may be so-equipped as for modular fitting); wherein the at least one end to each modular-section comprises silicone to provide weather resistance. As such, the landscape edging and illumination assembly is able to be snap-fit into an adjacent landscape edging and illumination assembly for use as per particular application desired by consumer.

A slit enables the lighting string to be inserted into the tubular member via passage through the slit in the tubular member progressively therealong; the slot allows the lighting string to be passed therethrough; wherein the landscape edging and illumination assembly is able to be modularly removably coupled for fitment to the project in the ground volume.

A kit is also disclosed herein including: at least one landscape edging and illumination assembly having the planar member, tubular member, and the lighting string, and a set of user installation instructions. A method of use is also described herein.

The present invention holds significant improvements and serves as a landscape edging and illumination system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, landscape edging and illumination system, constructed and operative according to the teachings of the present invention.

FIG. 1 shows a perspective view illustrating a landscape edging and illumination system during an ‘in-use’ condition according to an embodiment of the present invention.

FIG. 2 is a perspective view illustrating the landscape edging and illumination system comprising a landscape edging and illumination assembly according to an embodiment of the present invention of FIG. 1.

FIG. 3 is a perspective view illustrating the landscape edging and illumination assembly according to an embodiment of the present invention of FIGS. 1-2.

FIG. 4 is a perspective view illustrating the landscape edging and illumination assembly according to an embodiment of the present invention of FIGS. 1-3.

FIG. 5 is a flowchart illustrating a method of use for the landscape edging and illumination system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to landscaping accessories and more particularly to a landscape edging and illumination system as used to improve the functional and structural illumination and edging of landscapes.

Generally speaking, The present invention is a combination of landscape edging and landscape lighting, wherein the illumination so provided is pleasing and safe from harm. Lighting may be provided using solar means.

The illuminated landscape edging according to the present invention is composed of a planar member which is structured to be implanted into the ground and by a tubular member which is structured to be located above ground. The planar member is optionally provided with a medial ribbing and an end hook for serving to anchor the planar member into the ground. In the most preferred form of the invention, the sidewall of the tubular member is constructed of a light passable material and is provided with a slit running its length. Both the planar and tubular members are integrally constructed of plastic. The illuminated landscape edging is elongated and is provided in long rolls which may be cut into sections to suit the length needs of a particular landscaping job. Sections of the illuminated landscape edging are serially joined by a slotted tubular connector inserting into open ends of adjoining tubular members.

A lighting string, such as miniature Christmas lights, may be inserted into the tubular member via passage through the slit in the tubular member progressively therealong. A slot in the slotted tubular connector enables the lighting string to be passed therethrough, as well. At a selected location along the slit in the tubular member, the wiring of the lighting string exits the tubular member to be connected externally to a power source of electricity, which may be the home utility service or a solar energy storage power system of conventional manufacture.

In the nighttime hours, the lighting string is illuminated, thereby providing a pleasant line of light which follows the predetermined demarcation pattern of the illuminated landscape edging. The lighting string is encapsulated by the tubular member, thereby protecting it from injury. In the event any of the lights of the lighting string need service, it is a simple matter to access the subject light via the slit in the tubular member.

Novel use of plastic tubing is employed not simple round tubing that “pressure fits” into the edging. The tubing comprises grooves along both sides that snap in to the corresponding projections in the holder portion of the edging. The present invention also has internal solar lighting. The solar lighting is attached to an on/off mechanism. The ends are plugged with silicone to keep the system weather resistant.

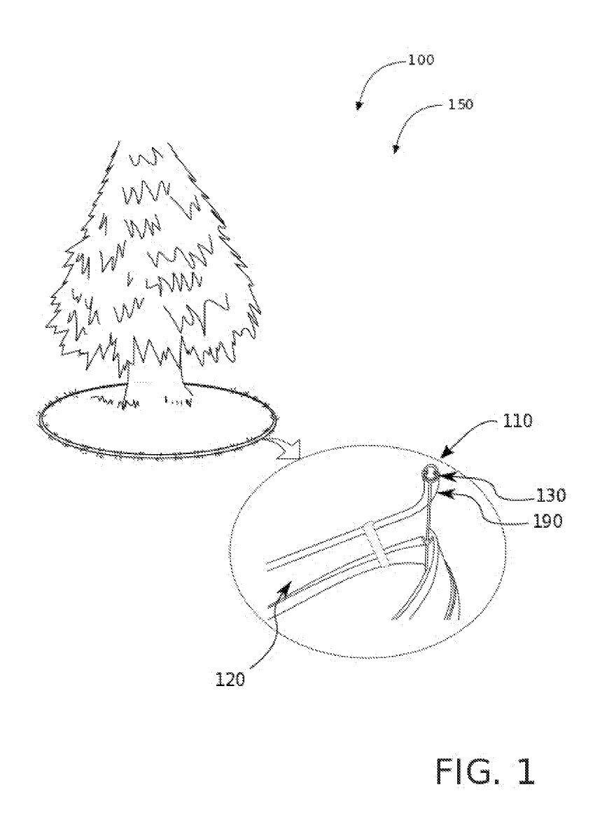

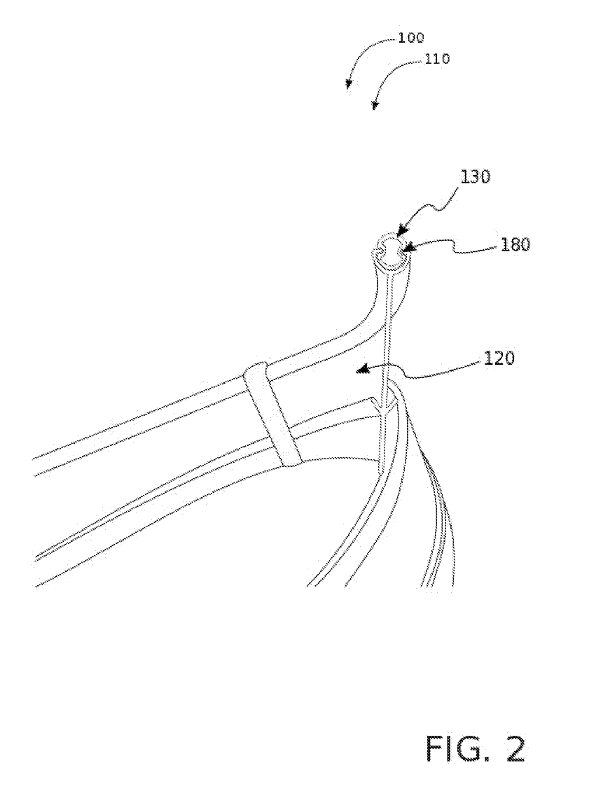

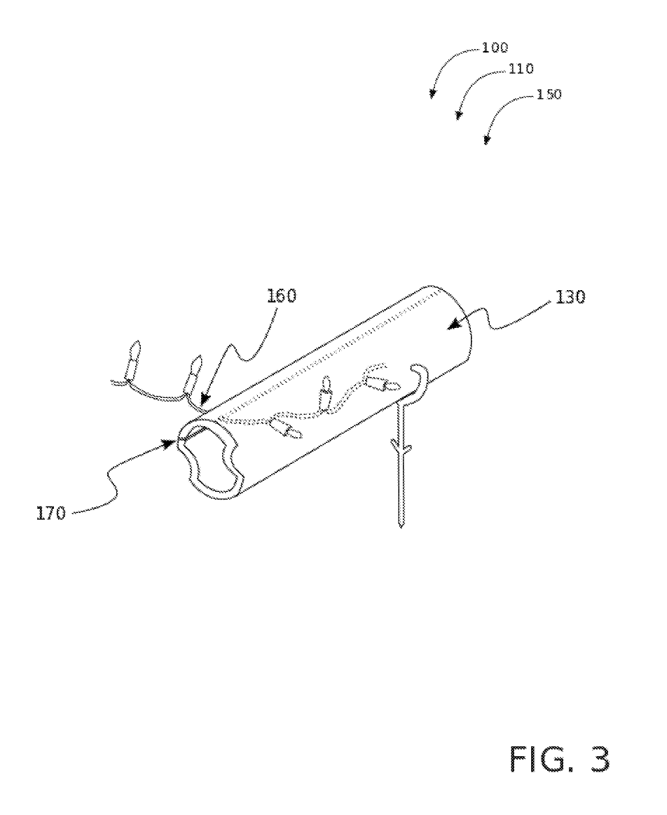

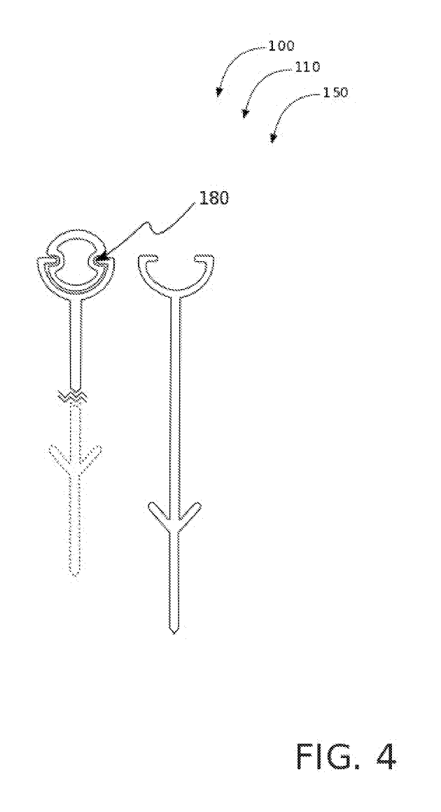

Referring to the drawings by numerals of reference there is shown in FIGS. 1-4, various views of landscape edging and illumination system 100 comprising: landscape edging and illumination assembly 110 having planar member 120, tubular member 130, and lighting string 160; wherein planar member 120 is flexible (yet sufficiently sturdy) and structured to be implanted into a ground volume.

Referring now to tubular member 130; tubular member 130 is structured to be located above the ground. Landscape edging and illumination assembly 110 may be integrally assembled of plastic to provide longevity in service; wherein landscape edging and illumination assembly 110 is able to be cut to a desired length such that they can be fit to a particular landscaping project to illuminate such project during low light periods. Landscape edging and illumination assembly 110 is configured to be vertically-installed, as shown. As such, landscape edging and illumination assembly 110 is able to be modularly removably coupled for fitment to the landscaping project.

Planar member 120 may comprise medial ribbing and an end-hook; wherein end-hook anchors planar member 120 into a ground volume in a desired positioning. Landscape edging and illumination assembly 110 comprises at least one end to each modular-section; wherein the at least one end to each modular-section comprises silicone to provide weather resistance. Slit 170 enables lighting string 160 to be inserted into tubular member 130 via passage through slit 170 in tubular member 130 progressively therealong; and slot 180 allows lighting string 160 to be passed therethrough.

Side wall 190 of tubular member 130 is transparent; side wall 190 of tubular member 130 preferably comprises slot 180; wherein lighting string 130 passes through slot 180. Lighting string 130 comprises necessary wiring to be connected to an external power source of electricity which may be a home utility service or solar energy collecting and providing means and solar energy storage means (an excellent option for use on remote landscaping projects). As designed, landscape edging and illumination assembly 110 is able to be snap-fit into an adjacent landscape edging and illumination assembly 110 for use to form landscape edging and illumination system 100; wherein landscape edging and illumination assembly 110 is able to be controlled via an on/off switch.

It should be noted that landscape edging and illumination system 100 may be sold as kit comprising the following parts: at least one at least one landscape edging and illumination assembly 110 having planar member 120, tubular member 130, and lighting string 160, and a set of user installation instructions. The kit has instructions such that functional relationships are detailed in relation to the structure of the invention (such that the invention can be used, maintained, or the like in a preferred manner). Landscape edging and illumination 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

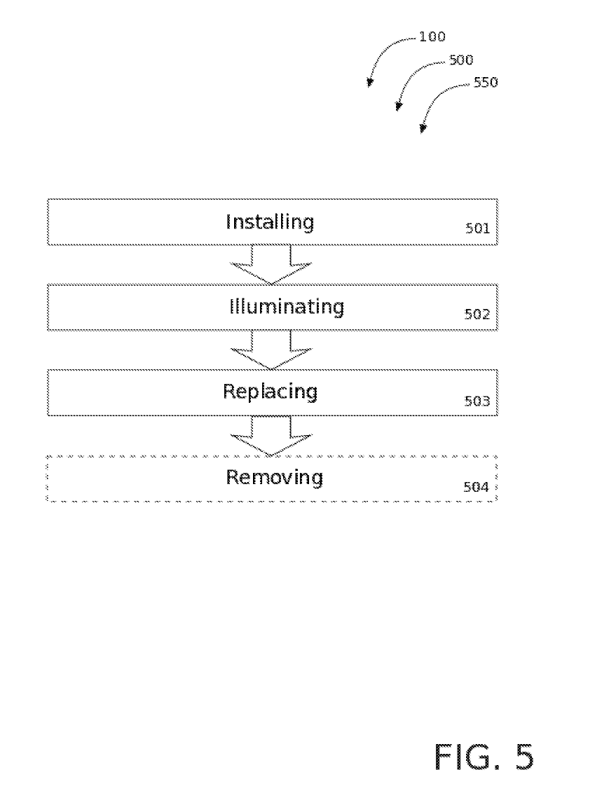

Referring now to FIG. 5 showing flowchart 550 illustrating method of use 500 for landscape edging and illumination 100 according to an embodiment of the present invention of FIGS. 1-4. As shown, method of use 500 may comprise the steps of: step one 501, contourly and modularly installing landscape edging and illumination assembly; step two 502 illuminating an edging defined by landscape edging and illumination assembly via illuminators activated by an on/off switch; step three 503 replacing illuminators as needed; and step four 504 removing landscape edging and illumination assembly or moving it as desired.

It should be noted that step 504 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A landscape edging and illumination system comprising:
a landscape edging and illumination assembly having;
a planar member;
a tubular member; and
a lighting string;
wherein said planar member is flexible and structured to be implanted into a ground volume;
wherein said tubular member is structured to be located above ground; and
wherein said landscape edging and illumination assembly is integrally assembled of plastic to provide longevity in service;
wherein said landscape edging and illumination assembly is able to be cut to a desired length such that they can be fit to a particular landscaping project to illuminate such project during low light periods, said landscape edging and illumination assembly configured to be vertically-installed; and
wherein said landscape edging and illumination assembly is able to be modularly removably coupled for fitment to said project.

2. The landscape edging and illumination system of claim 1 wherein said planar member comprises medial ribbing.

3. The landscape edging and illumination system of claim 1 wherein said planar member comprises an end-hook.

4. The landscape edging and illumination system of claim 3 wherein said end-hook anchors said planar member into a ground volume.

5. The landscape edging and illumination system of claim 1 wherein a side wall of said tubular member is transparent.

6. The landscape edging and illumination system of claim 1 wherein said side wall of said tubular member comprises a slot.

7. The landscape edging and illumination system of claim 6 wherein said lighting string passes through said slot.

8. The landscape edging and illumination system of claim 1 wherein said lighting string comprises wiring to be connected to an external power source of electricity.

9. The landscape edging and illumination system of claim 8 wherein said external power source of electricity comprises home utility service.

10. The landscape edging and illumination system of claim 8 wherein said external power source of electricity comprises solar energy storage.

11. The landscape edging and illumination system of claim 1 wherein said landscape edging and illumination assembly is able to be snap-fit into an adjacent said landscape edging and illumination assembly for use.

12. The landscape edging and illumination system of claim 1 wherein said landscape edging and illumination assembly is able to be controlled via an on/off switch.

13. The landscape edging and illumination system of claim 1 wherein said landscape edging and illumination assembly comprises at least one end to each modular-section.

14. The landscape edging and illumination system of claim 13 wherein said at least one end to each modular-section comprises silicone to provide weather resistance.

15. The landscape edging and illumination system of claim 6 wherein a slit enables said lighting string to be inserted into said tubular member via passage through said slit in said tubular member progressively therealong.

16. The landscape edging and illumination system of claim 15 wherein said slot allows said lighting string to be passed therethrough.

17. A landscape edging and illumination system comprising:
a landscape edging and illumination assembly having;
a planar member;
a tubular member; and
a lighting string;
wherein said planar member is flexible and structured to be implanted into a ground volume;
wherein said planar member comprises medial ribbing;
wherein said tubular member is structured to be located above ground;
wherein a side wall of said tubular member is transparent;
wherein said planar member comprises an end-hook;
wherein said end-hook anchors said planar member into a ground volume;
wherein said end-hook anchors said planar member into said ground volume;
wherein said landscape edging and illumination assembly is integrally assembled of plastic to provide longevity in service;
wherein said side wall of said tubular member comprises a slot;
wherein said lighting string passes through said slot;
wherein said lighting string comprises wiring to be connected to an external power source of electricity;
wherein said external power source of electricity comprises solar energy storage;
wherein said landscape edging and illumination assembly is able to be controlled via an on/off switch;
wherein said landscape edging and illumination assembly is able to be cut to a desired length such that they can be fit to a particular landscaping project to illuminate such project during low light periods, said landscape edging and illumination assembly configured to be vertically-installed;
wherein said landscape edging and illumination assembly comprises at least one end to each modular-section;
wherein said at least one end to each modular-section comprises silicone to provide weather resistance;
wherein said landscape edging and illumination assembly is able to be snap-fit into an adjacent said landscape edging and illumination assembly for use;
wherein a slit enables said lighting string to be inserted into said tubular member via passage through said slit in said tubular member progressively therealong;
wherein said slot allows said lighting string to be passed therethrough; and
wherein said landscape edging and illumination assembly is able to be modularly removably coupled for fitment to said project in said ground volume.

18. The landscape edging and illumination system of claim 17 further comprising a kit including:
at least one said landscape edging and illumination assembly having,
said planar member,
said tubular member, and
said lighting string; and
a set of user installation instructions.
